(19) United States
(12) Patent Application Publication
(10) Pub. No.: US 2007/0103887 A1
(43) Pub. Date: May 10, 2007

(54) Switching device and arrangement for detecting various positions of a door element

(75) Inventors: Konrad Bleier, Weisenbach (DE); Walter Gramlich, Bruchsal (DE); Bernhard Gotz, Zaisenhausen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, Munich (DE)

(21) Appl. No.: 10/580,719

(22) PCT Filed: Nov. 26, 2004
(86) PCT No.: PCT/EP04/53127

§ 371 Date: May 24, 2006

(30) Foreign Application Priority Data
Nov. 28, 2003 (DE) 103 55 603.6

(51) Int. Cl. F27D 11/00; F25D 27/00

(52) U.S. Cl. 362/92; 219/391

(57) ABSTRACT

A switching device includes a movable switching element and an electrical switch in operative connection to the switching element. The switching element is operable to selectively separate the operative connection between the switching element and the electrical switch. The interaction between the switching element and the electrical switch can be blocked. Also, an arrangement for detecting at least two different positions of a mobile door element is provided, wherein an interaction between the door element and the switching element can also be blocked. The inventive arrangement and switching device are especially suitable for using in household appliances such as electrical refrigerators or cooking appliances.

The present invention relates to a switching device, especially a door contact switch according to the preamble of claim 1. The invention further relates to an arrangement for detecting different positions of a door element according to the preamble of claim 6. The invention further relates to a household appliance according to the preamble of claim 11.

In electrical household appliances a function can be provided which switches on or switches off an interior light and/or other electrical loads when a door is opened. This function is more appropriately triggered by means of a so-called door contact switch since this can provide a reliable switching signal according to the opening position of the door. Door contact switches of this type usually comprise a control element which can be displaced against the force of a spring, which is in operative connection with an electric switch. If the door is brought from its closed position into an open position, the control element, for example a striker which can be displaced by spring force, is actuated. The switch is hereby triggered and delivers a different switching signal compared with the pressed position of the striker. Door contact switches of this type are used in refrigerators for switching on an interior light and can activate cooking chamber lighting in cooker appliances as soon as a baking oven door is opened.

It can possibly be desirable to dispense with switching on the interior lighting or cooking chamber lighting when opening the door. Such a function is known as the so-called Sabbath circuit which prevents any lighting from being switched on when the baking oven door is opened. Such a Sabbath mode can be desirable or necessary for religious reasons. Methods and devices for operating cooker appliances with a so-called Sabbath mode are known, among other things, from U.S. Pat. No. 5,808,278 and from U.S. Pat. No. 6,066,837. In this case, any manual influence on certain functions of the cooking appliance during certain definable time intervals is prevented by means of electronic circuits.

It is an object of the present invention to be able to simply influence a mechanical switching function when opening a door element of an electrical household appliance.

This object is solved in a switching device having the features of the preamble of claim 1 by an operative connection between a mechanical switching element and an electrical switch actuated thereby being separable. The switching device according to the invention thus makes it possible to deactivate as required an electrical switching function normally triggered by the switching element. Such a switching function can, for example, be cooking chamber lighting which can be switched on by opening a baking oven door in a cooking appliance. The electrical switching function can, for example, also switch off an electrical hot air fan of an oven muffle of a cooking appliance when a door to the cooking chamber is opened. In this way, the switching-on and switching-off function for the cooking chamber lighting and/or for further loads can be deactivated by separating the operative connection between switching element and electrical switch.

A wide range of switching functions can be triggered by means of the switching device according to the invention. In an electrical refrigeration for example, the switching function can effect the switching on of an interior lighting when opening a front door. The separable operative connection between the switching element and the electrical switch can have the result that the interior lighting is no longer switched on as soon as the door is opened.

A particular advantage of the mechanically deactivatable switching function is that by using the switching device according to the invention, it is possible to provide electrical household appliances which have or allow a so-called Sabbath function. Since some religions do not allow any electrical lighting to be switched on during certain time intervals, for example, during the Sabbath after dusk has fallen, the problem can arise that a cooking appliance which has a switching function for switching on a cooking chamber light on opening the baking oven door can no longer be used during the Sabbath. Otherwise, it could occur, for example, that a cooking process was started before dusk had fallen and continued beyond this. Then, it would no longer be possible to open the baking oven door without previously switching off the appliance. However, switching on the appliance again to finish cooking also would no longer be possible since this is also forbidden during the Sabbath. The switching device according to the invention allows all these switching functions to be deactivated simply and inexpensively by separating the operative connection between the switching element and the electrical switch before the cooking process is begun.

In principle, the switching device according to the invention is suitable for building into all electrical appliances wherein the opening of a door should trigger a switching function. Refrigerators or freezers can also be provided with a Sabbath function in this way where the light basically remains switched off even when the door is opened. In addition, in many other household appliances switching functions associated with an opening of a door element can be deactivated.

The switching element can optionally execute a substantially translational or rotational movement between its at least two operating positions. In the case of a translational movement of the switching element, this can preferably be a striker which can be displaced linearly against a spring force which is displaced by contact with a door element. The housing element can in particular be an openable housing flap of the household appliance, for example, a front door or front flap of a cooking chamber of a cooking appliance or a refrigerator door or the like. In this way, the switching device forms a door contact switch consisting of a switch, a spring, a housing and a striker which utilise the position of the door in cooperation.

The electrical switch can in this way optionally close a contact or trigger an electrical or electronic unit positioned subsequently. When the door element is opened or at least partly opened, the switching element or the striker is pushed by the action of the spring force into its first operating position which is thus a rest position. When the door element is closed, the switching element or striker is pressed into its second operating position. The electrical switch can especially have a displaceable switching pin which can be actuated by a cam on the external circumference of the displaceable striker.

In a first embodiment of the invention, the striker can be executed as rotatable about its longitudinal axis so that the operative connection between the switching element and the electrical switch can be separated by turning the striker through a certain angle. The cam on the outer circumference of the displaceable striker thus must not describe the entire circumference of the striker but only a circumferential segment so that by simply turning the striker, the operative connection between the actuatable switching pin of the switched and the displaceable striker is separated. A user can thus actively or passively switch the door interrogation by simply turning the striker.

An advantageous variant can provide that two or more cams are provided on the outer circumference of the striker so that by a respective turn of the striker through an angle of about 90 degrees, for example, it is possible to activate or deactivate the door contact switch. These at least four different angular positions of the striker are preferably defined by a suitable locating element which can prevent any unintentional twisting of the striker.

An arrangement according to the invention for detecting at least two different positions of a movable door element having the features of claim 6 provides that an operative connection between the door element and the switching device according to the invention can be separated. In this arrangement, the striker can be brought out of the region of engagement of the door element, for example, by displacement or lowering. The striker can optionally also be lowered by means of a link mechanism, similar to a ball pen mechanism, and can thus be brought out of the region of engagement of the door element. As a result of lowering the striker, the door no longer reaches the striker in the closed state. The switching function normally triggered with a displacement of the striker from its first operating position into the second operating position is no longer triggered. As a result of the striker being released by the user, the door again reaches the striker in the closed state. The switching function which can thereby be triggered, is triggered again.

An alternative variant provides that the operative connection between the switching device and the door element can be separated by exposing a depression disposed in the door element for receiving the striker. The depression can be exposed, for example, by means of a slider so that when the door element is closed and the slider is opened, the striker can dip into the depression exposed hereby.

The invention has the advantage that the user of the electrical appliance can himself determine whether the recognition of the door end position is switched on or not. The user can hereby also directly influence various functions coupled to this door interrogation. For example, this can be switching on or off lighting, energy saving, heating or a hot air fan motor or the like.

The switching device according to the invention or the arrangement according to the invention is especially suitable for incorporation into a household appliance according to any one of claims 11 to 13.

Further preferred and advantageous variants and further developments of the invention can be deduced from the dependent claims and the following description of the figures.

The invention is explained hereinafter with reference to a preferred exemplary embodiment where reference is made in detail to the appended drawings. In the figures:

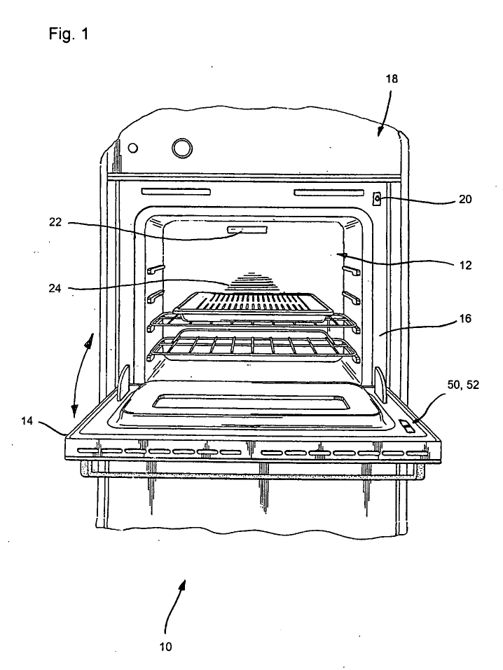

FIG. 1 is a schematic front view of a cooking appliance with opened front flap and cooking chamber accessible at the front,

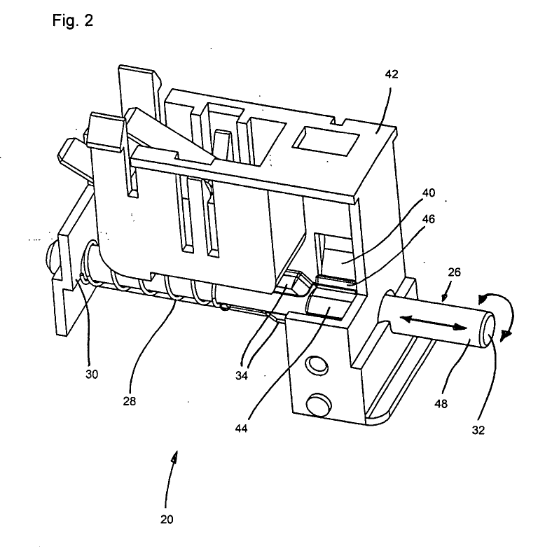

FIG. 2 is a schematic perspective diagram of an embodiment of a switching device according to the invention and

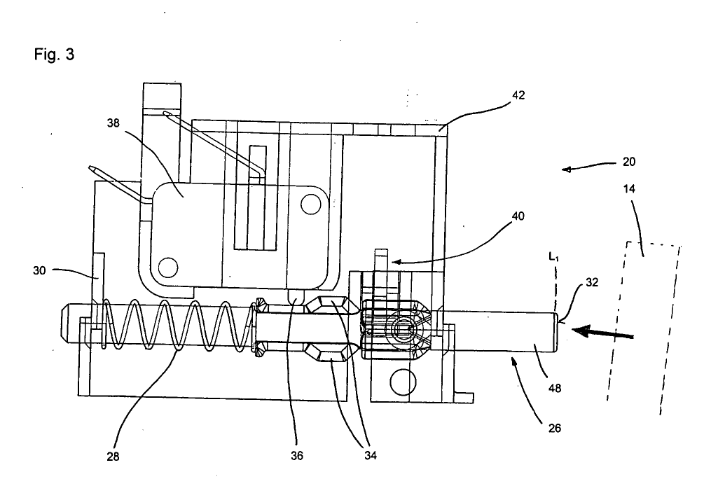

FIGS. 3 to 5 are schematic diagrams of the switching device according to FIG. 2 in respectively different operating states.

The cooking appliance 10 according to FIG. 1 has a cooking chamber 12 which is accessible from outside in the horizontal direction by means of a downwardly pivotable front flap 14. Located at the side on a frame 16 of a housing front 18 of the cooking appliance 10 is a door contact switch 20 which, when the front flap 14 is closed, is covered thereby and thus cannot be seen from outside. The door contact switch 20 is switched by the front flap 14 and thus has at least two operating states. A first operating state characterises a closed front flap 14 whereas a second operating state characterises an at least partly opened front flap 14. The door contact switch 20 can, for example, switch a cooking chamber light 22, an electrical hot air fan 24 or other electrical loads of the cooking appliance 10.

According to the present invention, the door contact switch 20 can be deactivated so that the switching functions normally provided by opening and closing the front flap 14 are no longer triggered.

The operating mode of the deactivatable switching functions is explained in detail with reference to a preferred exemplary embodiment of the door contact switch 20 with reference to FIGS. 2 to 5.

An alternative variant for deactivation of the door contact switch 20 by means of a slider 50 arranged in the front flap 14 is explained further below.

The door contact switch 20 according to the invention comprises a switching element 26 which is in separable operative communication with an electrical switch 38. In the exemplary embodiment shown, the switching element 26 comprises a linearly displaceable striker 48 which is held in a first operating position L₁ by means of spring force. The first operating position L₁ is illustrated in FIGS. 2 and 3 respectively. In the exemplary embodiment the spring is embodied as a coil spring 28 which is arranged around the outer circumference of the striker 48 and supports this against a housing projection 30.

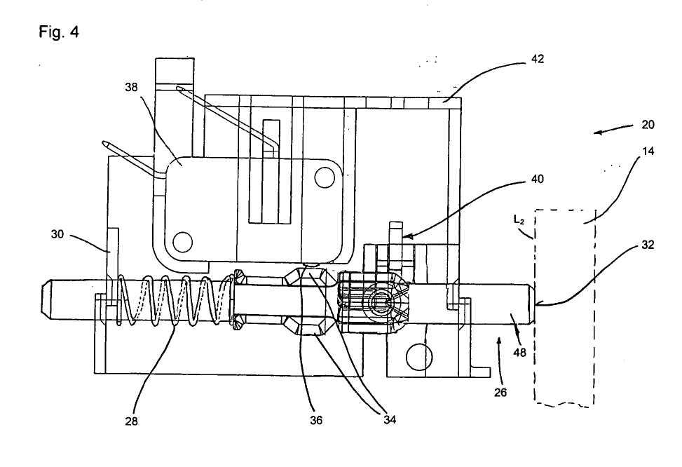

A front side 32 of the striker 48 can be contacted by the closing front flap 14 whereby, when the front flap 14 closes completely, the striker 48 is displaced to the left against the force of the coil spring 28 into a second operating position L₂ (see FIG. 4). As a result, a trip cam 34 located on the outer circumference of the striker 48 acts on a switching pin 36 of the electrical switch 38. The electrical switch 38 can, for example, be a conventional micro-switch whose electrical contact is opened or closed by linear displacement of the switching pin 36. The linear displacement of the striker is converted by means of the trip cams 34 into a linear displacement of the switching pin 36 of the electrical switch perpendicular hereto.

The afore-mentioned operative connection between the displaceable striker 48 and the electrical switch 38 is hereby realised. In each of the two operating positions L₁ and L₂ the electrical switch 38 remains deactivated since its switching pin 36 is no longer reached by one of the trip cams 34.

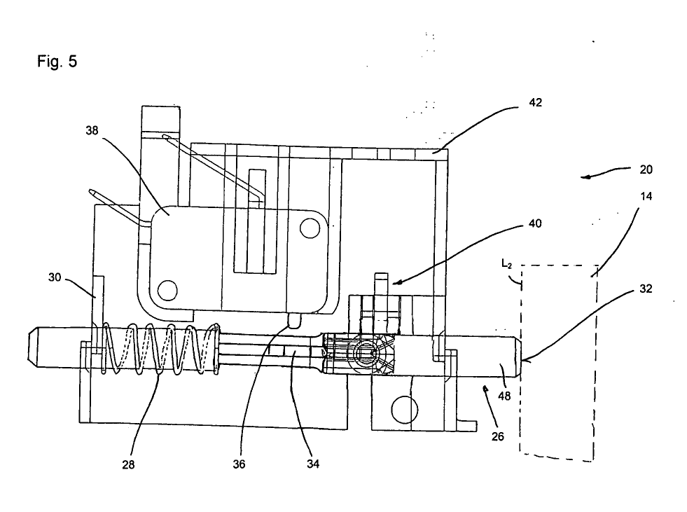

FIG. 5 illustrates the possible separation of the operative connection between switching element 26 and electrical switch 38. By twisting the striker 48 about its longitudinal axis, the trip cam 34 can be brought from the region of engagement with the switching pin 36 whereby the switching function of the door contact switch 20 according to the invention can be deactivated. The striker 48 is then further activated and linearly displaced by the opening or closing front flap 14 but the switching function of the electrical switch 38 is no longer triggered as a result of the trip cam 34 no longer actuating the switching pin 36. The door contact switch 20 is deactivated in this way and no longer triggers any electrical switching function. In this way, the operative connection between the switching element 26 and the electrical switch 38 can be separated according to the invention.

In order to stabilise the activated or deactivated operative connection between the switching element 26 and the electrical switch 38 of the door contact switch 20, a locating spring 40 is provided which is anchored in the housing 42 of the door contact switch 20 and acts on a corresponding recess or elevation on the outer circumference of the striker 48. The locating spring 40 can, for example, by a leaf spring or the like whose free end can engage in separate recesses 44 on the outer circumference of the striker 48. In this case, the two recesses 44 are preferably separated from one another by a web 46 or the like over which the locating spring 40 must slide when the striker 48 is twisted about its longitudinal axis. In this way, the striker 48 can be stabilised in at least two possible angular positions which each characterise an activation or deactivation of the door contact switch 20.

A preferred embodiment of the door contact switch 20 according to the invention can provide that the striker 48 can be twisted in each case in a pre-determined direction through 90 degrees. A defined angular position of the locating spring 40 can ensure that any twisting in the other direction is blocked. In this variant, at least four separate recesses 44 are provided on the outer circumference of the striker 48, each separated from one another by webs 46 so that the locating spring 40 can in each case be in engagement with one of the four recesses 44 whereby respectively one of the two possible states of the door contact switch 20 can be defined. In this way, the operation of the door contact switch 20 is very much simplified since the user need not take into consideration whether the striker 48 is located in the correct angular position. The striker 48 only needs to be twisted by 90 degrees further in the defined direction to thereby activate or deactivate the operative engagement between the trip cam 34 and the switching pin 36.

It can optionally be advantageous if the possible angular positions of the striker 48 are characterised by means of small coloured markings so that the user can read off in each case whether the door contact switch 20 is activated or deactivated. This makes it possible to assess the operating state of the door contact switch 20 without the cooking appliance 10 first needing to be switched on.

An alternative possibility for deactivating the switching functions of the door contact switch 20 consists in no longer displacing the striker 48 into its second operating position L₂ when the front flap 14 is completely closed but staying in its first operating position L₁ at all times. This can be achieved, for example, by a slider 50 being opened on the inside of the front flap 14 pointing towards the door contact switch 20 so that the part of the striker 48 projecting from the frame 16 of the cooking appliance 10 can dip into a depression 52 which had previously been closed by the slider 50. This depression 52 is preferably so deep that even when the front flap 14 is completely closed, the striker 48 is not pressed but is held by the force of the coil spring 28 in its first operating position L₁.

### REFERENCE LIST

10 Cooking appliance

12 Cooking chamber

14 Front flap

16 Frame

18 Housing front

20 Door contact switch

22 Cooking chamber light

24 Hot air fan

26 Switching element

28 Coil spring

30 Housing projection

32 Front side

34 Trip cam

36 Switching pin

38 Electrical switch

40 Locating spring

42 Housing

44 Recess

46 Web

48 Striker

50 Slider

52 Depression

L₁ First operating position

L₂ Second operating position

1-13. (canceled)

14. A switching device comprising:
a movable switching element; and
an electrical switch in operative connection to the switching element, the switching element being operable to selectively separate the operative connection between the switching element and the electrical switch.

15. The switching device according to claim 14, wherein the movable switching element includes a striker that can be displaced linearly against a biasing force.

16. The switching device according to claim 15, wherein the electrical switch has a displaceable switching pin which can be actuated by a trip cam provided on the outer circumference of the displaceable striker.

17. The switching device according to claim 15, wherein the striker is rotatable about its longitudinal axis.

18. The switching device according to claim 15, wherein the striker is operable to separate the operative connection between the switching element and the electrical switch.

19. An arrangement for detecting at least two different positions of a movable door element, the arrangement comprising:
a switching device having a movable switching element and an electrical switch in operative connection to the switching element, the switching element being operable to selectively separate the operative connection between the switching element and the electrical switch, the door element and the switching device having an operative connection therebetween and the operative connection between the door element and the switching device being selectively separable.

20. The arrangement according to claim 19, wherein the movable switching element includes a striker and the striker being movable out of a region of engagement of the door element by at least one of a displacement and a lowering movement.

21. The arrangement according to claim 19, wherein the striker can be lowered by means of a link mechanism.

22. The arrangement according to claim 19, wherein the operative connection between the switching device and the door element can be separated by exposing a depression arranged in the door element to partly receive the striker.

23. The arrangement according to claim 22, wherein the depression can be exposed by means of a slider arranged in the door element.

24. A household appliance comprising:
at least one electrical load in the form of a selected one of an electrical interior light and an electrical load that is not an electrical interior light, the at least one electrical load being actuable by a selected one of a switching device having a movable switching element and an electrical switch in operative connection to the switching element with the switching element being operable to selectively separate the operative connection between the switching element and the electrical switch and an openable door element arrangement including a switching device having a movable switching element and an electrical switch in operative connection to the switching element with the switching element being operable to selectively separate the operative connection between the switching element and the electrical switch and the door element and the switching device having an operative connection therebetween and the operative connection between the door element and the switching device being selectively separable.

25. The household appliance according to claim 24, wherein the switching-on and switching-off function for the at least one electrical load can be deactivated by separating the operative connection between the switching element and the electrical switch.

26. The household appliance according to claim 24, wherein the switching-on and switching-off function for the at least one electrical load can be deactivated by separating the operative connection between the switching device and the door element.
